(19) United States
(12) Patent Application Publication
(10) Pub. No.: US 2026/0146929 A1
(43) Pub. Date: May 28, 2026

(54) IMPACT TEST SYSTEM AND METHOD OF TESTING A HELMETED IMPACT

(71) Applicant: Government of the United States, as represented by the Secretary of the Army, Washington, DC (US)

(72) Inventor: Daniel P Boyle, Clawson, MI (US)

(73) Assignee: Government of the United States, as represented by the Secretary of the Army, Washington, DC (US)

(21) Appl. No.: 18/958,525

(22) Filed: Nov. 25, 2024

(51) Int. Cl. G01N 3/307

(52) U.S. Cl. CPC G01N 3/307; G01N 2203/0405; G01N 2203/0447

(57) ABSTRACT

An impact test system and method includes an arm that supports a helmeted headform in a mounted position. The arm includes a tube, collar, anti-rotation protrusion, and piston. The tube and collar are disposed about a translation axis. The collar is coupled to an end of the tube. The collar includes a lower contact surface the abuts a lower rear portion of the headform in the mounted position. The anti-rotation protrusion is coupled to the collar and includes an upper contact surface that is radially outward of the lower contact surface and abuts an upper rear portion of the headform in the mounted position. The piston extends within the tube for translation relative thereto along the translation axis between retracted and extended positions such that an end portion of the piston ejects the helmeted headform away from the collar toward an impact surface, free from the arm.

### GOVERNMENT INTEREST

The embodiments described herein may be manufactured, used, and/or licensed by or for the Government of the United States of America without payment by the Government of any royalties thereon.

### TECHNICAL FIELD

The present disclosure relates to an impact test system and method of testing a helmeted impact.

### BACKGROUND

The statements in this section merely provide background information related to the present disclosure and may not constitute prior art.

One method of testing a head impact against a surface is to eject a free headform toward the surface. One known method and system is described in the Federal Vehicle Safety Standard (FMVSS) 201U, “Occupant Protection in Interior Impact-Upper Interior Head Impact Protection-,” which is incorporated herein by reference in its entirety and referred to herein simply as “FMVSS 201U.”

With reference to FIG. 1, a free headform 10 is a device that is shaped similar to a human head and is not connected to a torso via a neck. Typically, the free headform 10 includes one or more sensors (only one sensor 14 is shown for ease of illustration) configured to record impact forces, acceleration, moment, and/or other data relevant to the impact. In the example provided these sensors 14 are located within the free headform 10 in a chamber 18 defined therein, though other configurations can be used such as sensors located on an exterior surface of the free headform 10 or embedded in the material of the free headform 10. In the example provided, the chamber 18 is closed by a cover 22 which is a metal plate that defines a rear surface 26 of the free headform 10. The cover 22 can be removable to permit access to the chamber 18. In the example provided, the sensors 14 are connected to a control module 30 via a cable 34, though wireless communications can be used. The cover 22 defines a rear aperture 38 open through the rear surface 26 for mounting the free headform 10 to a test fixture 42 (shown in FIG. 2).

With reference to FIGS. 2 and 3, test systems such as those in FMVSS 201U include the test fixture 42, the free headform 10, and an impact object 46. The test fixture 42 includes an ejector 50 that is configured to eject the free headform 10 toward the impact object 46 such that a front 48 of the free headform 10 will impact the impact object 46. The ejection is such that the free headform 10 is not attached to the test fixture 42 at impact. In other words, the ejector 50 imparts a force on the rear surface 26 of the free headform 10 to start motion of the free headform 10 toward the impact object 46 and the free headform 10 then travels freely from the test fixture 42 toward the impact object 46.

As shown in FIG. 2, the free headform 10 is mounted to an arm 54 of the ejector 50 such that a portion of the rear surface 26 engages a collar 58 of the arm 54. With additional reference to FIG. 3, the arm 54 includes a tube 62, the collar 58, a piston 66 and the ejector 50 further includes a propulsion device 70. The collar 58 is an annular body coupled to a distal end of the tube 62. The tube 62 defines an internal cylinder (not shown) in which a proximal end portion (not shown) of the piston 66 is translatably disposed therewithin. A distal end portion of the piston 66 can include a bushing 74 and a tip 78 that extends coaxially from the bushing 74. The bushing 74 is larger than the rear aperture 38 (FIG. 1) such that, in the mounted position shown in FIG. 2, the tip 78 is received in the rear aperture 38 (FIG. 1) while the bushing 74 engages the rear surface 26.

As shown in FIG. 3, operation of the test fixture 42 includes operating the propulsion device 70 to extend the piston 66 from the collar 58 to apply a force, via the bushing 74, along an axis 82 of the piston 66. This force ejects the free headform 10 from the test fixture 42. Typically, this axis 82 runs through a center of mass CG of the free headform 10 to promote stable flight of the free headform 10. The propulsion device 70 typically provides fluid pressure (e.g., via a pump and/or accumulator) to extend the piston 66, though other propulsion mechanisms can be used to impart the axial translation of the piston 66, such as a spring or a solenoid for example.

While tests such as FMVSS 201U provide useful data for non-helmeted head impacts, these known systems and methods are not capable of testing impacts representative of a person wearing a helmet. For example, with reference to FIG. 4, a rear of a combat helmet 86 (e.g., an Enhanced Combat Helmet, an Advanced Combat Helmet, a Modular Integrated Communications Helmet, or similar) blocks engagement between the collar 58 and the rear surface 26 of the free headform 10, thus preventing the free headform 10 from being mounted to and launched from the test fixture 42. Furthermore, a helmeted headform 90 (i.e., the free headform 10 wearing the combat helmet 86) has a different total center of gravity CG than the free headform 10 alone.

The invention of the present disclosure remedies these and other issues associated with the known head impact tests and systems by providing an improved impact test system and a method of testing a helmeted impact.

### SUMMARY OF THE INVENTION

This section provides a general summary of the disclosure and is not a comprehensive disclosure of its full scope or all of its features.

According to one form, the present disclosure provides for an impact test system including an arm. The arm is configured to support a helmeted headform in a mounted position. The helmeted headform includes a headform wearing a helmet. The arm includes a tube, a collar, an anti-rotation protrusion, and a piston. The tube is disposed about a translation axis. The collar is disposed about the translation axis and coupled to an end of the tube. The collar includes a lower contact surface configured to abut a lower rear portion of the headform in the mounted position. The anti-rotation protrusion is coupled to the collar and includes an upper contact surface that is radially outward of the lower contact surface and is configured to abut an upper rear portion of the headform in the mounted position. The piston extends within the tube and is coupled to the tube for translation relative thereto along the translation axis between a retracted position and an extended position such that an end portion of the piston is configured to push the headform out of the mounted position and eject the helmeted headform away from the collar toward an impact surface, free from the arm.

In variations of the impact test system of the above paragraph, which may be implemented individually or in any combination: the protrusion is located above the collar; the collar includes a magnet configured to magnetically couple the lower rear portion to the collar; the protrusion includes a magnet configured to magnetically couple the upper rear portion to the protrusion; the lower contact surface is a first planar surface having an annular shape disposed coaxially about the translation axis and the upper contact surface is a second planar surface coplanar with the first planar surface; the protrusion is removably coupled to the collar; the arm further includes a ring defining a central aperture disposed coaxially about the tube and axially translatable relative to the tube, wherein a proximal end of the protrusion is fixedly coupled to the ring and the protrusion extends axially forward of a front of the ring to a distal end of the protrusion, the distal end of the protrusion defining the upper contact surface; the distal end of the protrusion includes a magnet configured to magnetically couple the upper rear portion to the protrusion; at least one of the collar and the ring includes a magnet configured to magnetically couple the front of the ring to a rear of the collar; the ring and the protrusion are integrally formed of a non-ferromagnetic material; the proximal end of the protrusion is coupled directly to the front of the ring; the protrusion includes a flat surface facing radially outward, relative to the translation axis; the front of the ring includes an alignment feature configured to mate with a mating alignment feature defined by a rear of the collar to inhibit rotation of the ring about the translation axis relative to the collar, wherein the alignment feature is one of a protrusion and a recess and the mating alignment feature is the other one of the protrusion and the recess; the impact test system further includes a magnet fixedly coupled to a rear of the ring.

In another form, the present disclosure provides an anti-rotation insert for an impact test system. The anti-rotation insert includes a ring and a first magnet. The ring defines a central aperture disposed about a central axis and extends through a front of the ring and a rear of the ring. A proximal end of the protrusion is fixedly coupled to the ring and the protrusion extends axially forward of the front of the ring to a distal end of the protrusion. The first magnet is coupled to the distal end of the protrusion.

In variations of the anti-rotation insert of the above paragraph, which may be implemented individually or in any combination: the anti-rotation insert further includes a second magnet, the second magnet being fixedly coupled to the front of the ring; the ring and the protrusion are integrally formed of a non-ferromagnetic material; the front face includes an alignment feature configured to mate with a mating alignment feature of a test fixture to inhibit rotation of the ring about the central axis relative to the test fixture, wherein the alignment feature is one of a protrusion and a recess and the mating alignment feature is the other one of the protrusion and the recess.

In still another form, the present disclosure provides a method of testing a helmeted headform, the helmeted headform including a headform wearing a helmet. The method includes positioning the helmeted headform in a mounted position. In the mounted position, an arm of a test fixture extends through an opening of the helmet and is attached to the headform within the helmet. In the mounted position, a collar of the arm contacts a first portion of the headform within the helmet and a protrusion of the arm contacts a second portion of the headform within the helmet, wherein the first portion is disposed about a translation axis and the protrusion protrudes radially outward from the collar. The method includes impacting an object with the helmeted headform by extending an ejector relative to the collar to an extended position such that an end of an ejector moves forward of the collar to cause the helmeted headform to be ejected from the arm toward the object.

In one variation of the method of the above paragraph, the protrusion and the collar are magnetically coupled to the headform in the mounted position.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The present invention is described with respect to the following figures, wherein like reference numbers indicate substantially similar elements:

FIG. 1 is a schematic rear perspective view of an example free headform according to the prior art;

FIG. 2 is a schematic side view showing a prior art test system, including a test fixture and the free headform of FIG. 1, in a mounted state;

FIG. 3 is a schematic side view showing of the test system of FIG. 2, illustrating the test fixture and the free headform in a in an ejected state;

FIG. 4 is a schematic side view showing the free headform wearing a typical combat helmet to illustrate some of the issues with testing helmeted head impacts with the test system of FIG. 2;

FIG. 5 is a schematic perspective view of a test system, including a test fixture and a helmeted headform, according to the teachings of the present disclosure, illustrated in an ejected state;

FIG. 6 is a schematic rear perspective view of the helmeted headform of FIG. 5;

FIG. 7 is a schematic side view of the test system of FIG. 5, illustrating the helmeted headform mounted to the test fixture, according to the teachings of the present disclosure;

FIG. 8 is a perspective view of an anti-rotation insert of the test fixture of FIG. 5, according to the teachings of the present disclosure;

FIG. 9 is a front view of the anti-rotation insert of FIG. 8;

FIG. 10 is a side view of the anti-rotation insert of FIG. 8; and

FIG. 11 is a perspective view of a test system of a second form, according to the teachings of the present disclosure.

The drawings described herein are for illustration purposes only and are not intended to limit the scope of the present disclosure in any way.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention. In other instances, particulars of well-known components and manufacturing practices have been omitted so as to avoid unnecessarily obscuring the present invention. It should be understood that throughout the drawings, corresponding reference numerals indicate like or corresponding parts and features.

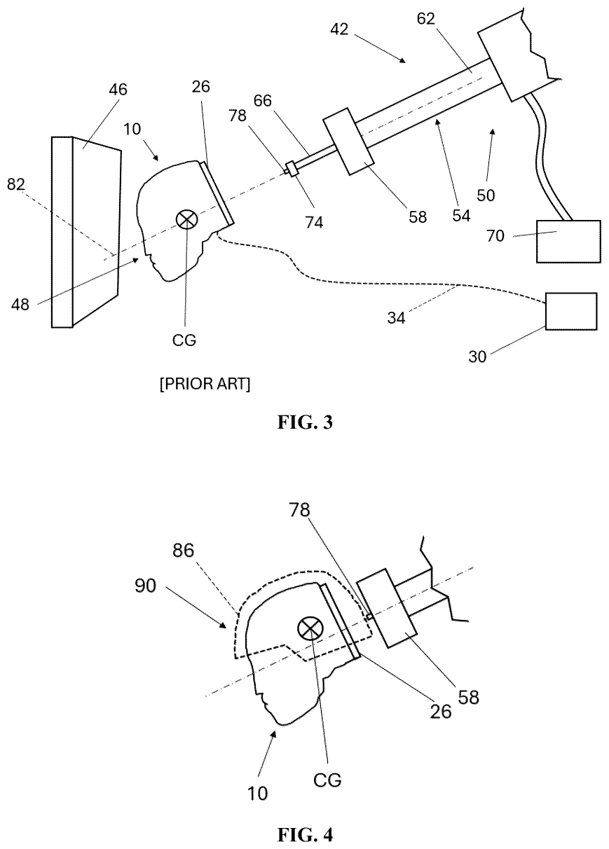

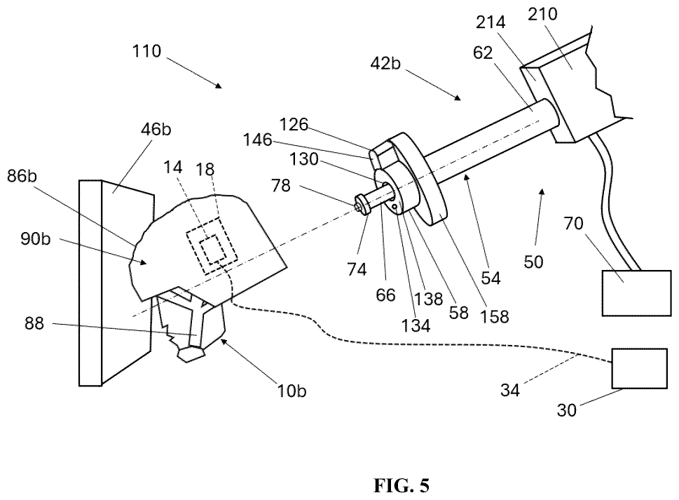

Referring to FIG. 5, one form of a test system 110 in accordance with the teachings of the present disclosure is illustrated. The test system 110 includes a test fixture 42b and a helmeted headform 90b. The test fixture 42b is configured to eject the helmeted headform 90b toward an impact object 46b. The impact object 46b can be any suitable object, such as the impact object 46 (FIG. 2).

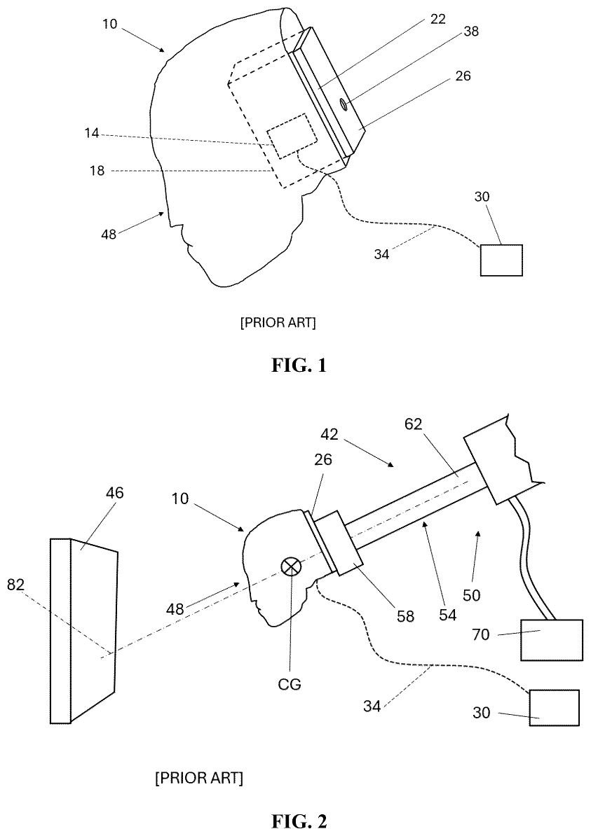

The helmeted headform 90b includes a helmet 86b and a free headform 10b wearing the helmet 86b. The free headform 10b is a device that is shaped similar to a human head and is not connected to a torso via a neck. The free headform 10b can be substantially similar to the free headform 10 (described above and shown in FIG. 1) except as otherwise shown or described herein. Similar features are indicated with similar reference numerals. As such, only differences and additional details will be described herein in detail. The helmet 86b can be attached to the free headform 10b via straps 88 (e.g., chin strap).

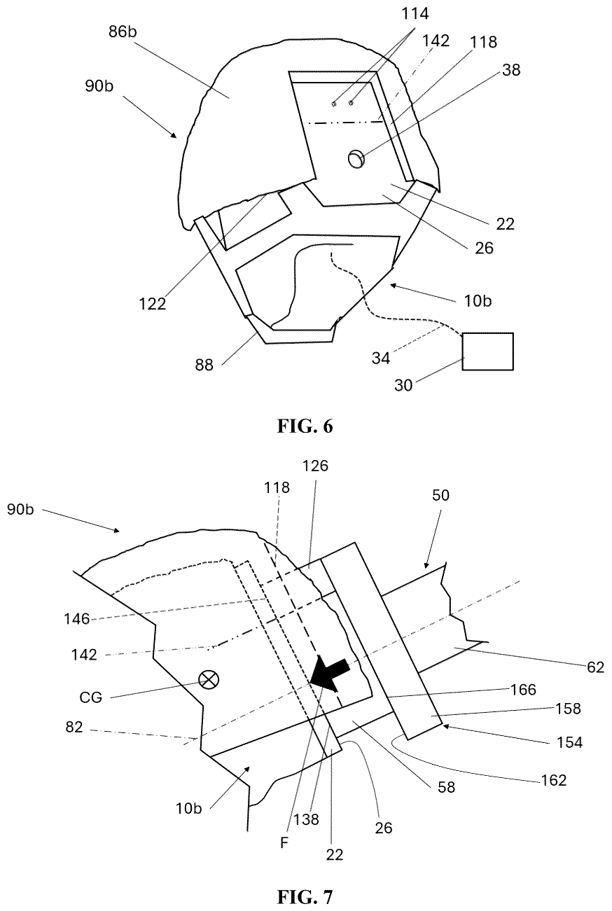

Referring to FIG. 6, the rear surface 26 of the cover 22 can optionally define one or more alignment feature 114. While two alignment features 114 are shown, one or more than two can be used. The alignment features 114 are described in greater detail below.

The helmet 86b can be a combat helmet (e.g., an Enhanced Combat Helmet, an Advanced Combat Helmet, a Modular Integrated Communications Helmet, or any other suitable helmet) that is modified or constructed to have a rear cut-out 118 that is an aperture that provides access from an exterior of the helmet 86b to an interior of the helmet 86b. In other words, the rear surface 26 of the free headform 10b is visible and accessible from an exterior of the helmet 86b via the rear cut-out 118 when the free headform 10 b is wearing the helmet 86 b. In the example provided, a lower rim 122 of the helmet 86 b is interrupted by the rear cut-out 118. The portion of the rear surface 26 that is visible through the rear cut-out 118 includes the rear aperture 38 and a surrounding area sufficient to receive the collar 58 (FIG. 7).

Returning to FIG. 5, the test fixture 42b can be substantially similar to the test fixture 42 (described above and shown in FIGS. 2 and 3) except as otherwise shown or described herein. Similar features are indicated with similar reference numerals. As such, only differences and additional details will be described herein in detail.

The test fixture 42b includes the ejector 50 and an anti-rotation protrusion 126. The ejector 50 includes the collar 58, the tube 62, the piston 66, and the propulsion device 70.

The piston 66 is configured to extend coaxially through a central aperture 130 of the collar 58. In the example provided, the collar 58 is formed of a ferromagnetic material, such as steel, though other materials or alloys can be used. In one form, a permanent magnet 134 can be coupled to the collar 58 such that the rear surface 26 (FIG. 6) of the cover 22 (FIG. 6) is magnetically attracted to a forward surface 138 of the collar 58. The forward surface 138 is a planar surface configured to contact a lower region (i.e., below line 142 shown in FIGS. 6 and 7) of the rear surface 26 (FIG. 6). The lower region of the rear surface 26 (FIG. 6) extends around the rear aperture 38 (FIG. 6) but does not extend into an upper region (i.e., above line 142 shown in FIGS. 6 and 7) of the rear surface 26. The upper region of the rear surface 26 (FIG. 6) is proximate to the top of the head-shape of the free headform 10b. The forward surface 138 does not engage the upper region of the rear surface 26 (FIG. 6). In the example provided, the forward surface 138 is an annular surface having an outermost diameter that defines the perimeter of the collar 58.

The anti-rotation protrusion 126 is coupled to a top portion of the collar 58 and extends radially outward therefrom. The anti-rotation protrusion 126 defines a forward surface 146 that is coplanar with the forward surface 138 of the collar 58 but is radially outward of the outermost diameter of the collar 58. As such, the forward surface 146 of the anti-rotation protrusion 126 is above the forward surface 138 of the collar 58. The anti-rotation protrusion 126 is a discrete protrusion and does not extend around the full circumference of the collar 58. The anti-rotation protrusion 126 is entirely radially outward of the central aperture 130. In the example provided, the anti-rotation protrusion 126 is entirely radially outward of the collar 58. In one form, the anti-rotation protrusion 126 has a maximum width 150 (FIG. 9) in a lateral direction (i.e., X direction as shown in FIG. 9) that is less than a diameter of the collar 58 (FIGS. 5 and 7) and is centered above the axis 82. In the example provided the maximum width 150 can also be less than a diameter of the central aperture 130, though other configurations can be used.

Referring to FIG. 7, the forward surface 146 is positioned such that a center of mass CG of the helmeted headform 90b is disposed between (in a radial direction relative to the axis 82) the axis 82 and the forward surface 146. The rear cut-out 118 extends upward sufficiently far enough so that the anti-rotation protrusion 126 can be received through the rear cut-out 118 and the forward surface 146 can engage the upper region of the rear surface 26.

In the example provided, the anti-rotation protrusion 126 is a portion of an anti-rotation insert 154 that is coupled to the ejector 50. The anti-rotation inset 154 includes a ring 158 and the anti-rotation protrusion 126. The ring 158 is configured to be coaxially disposed about the tube 62 and is axially slidable along the tube 62. In other words, the ring 158 defines an aperture 160 through which the tube 62 extends. The anti-rotation protrusion 126 extends, in an axial direction of the ring 158, from a top portion of a front surface 162 of the ring 158 a distance equal to an axial length of the collar 58. The front surface 162 of the ring 158 is configured to engage a rear surface 166 of the collar 58. As such, with the rear surface 166 of the collar 58 engaged to the front surface 162 of the ring 158, the front surface 146 of the anti-rotation protrusion 126 is flush with the front surface 138 of the collar 58.

The ring 158 is configured to be secured to the collar 58 in a manner that inhibits the axial sliding along the tube 62. Thus, when the ejector 50 is actuated such that the piston 66 (FIG. 5) imparts a force F along the axis 82, the additional contact surface area provided by the anti-rotation protrusion 126, above the center of mass CG, reduces rotation of the helmeted headform 90b compared to a test system without the anti-rotation protrusion 126.

In the example provided, the anti-rotation inset 154 is formed of a non-ferromagnetic material, such as a polymer, though other materials can be used including ferromagnetic materials.

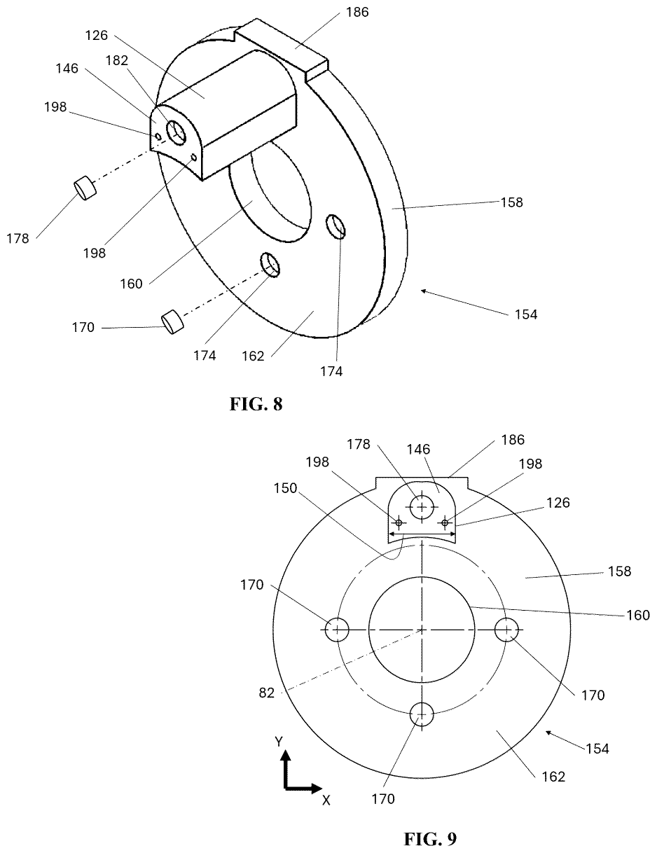

Referring to FIGS. 8-10, the ring 158 can include one or more permanent magnet 170 configured to magnetically attract the ring 158 toward the collar 58 (FIG. 7) to inhibit separation of the ring 158 from the collar 58. In the example provided, the front surface 162 of the ring 158 defines one or more recesses 174 and each recess 174 receives a corresponding magnet 170. While the front surface 162 defines three recesses 174 and, each having a corresponding magnet 170 (only one of which is shown in FIG. 8 for ease of illustration), any number can be used. In an alternative configuration, not specifically shown, the collar 58 (FIG. 7) can include one or more permanent magnets and the ring 158 can be made of a ferromagnetic material (e.g., steel) or can include corresponding ferromagnetic inserts configured to align with and be attracted to the magnets of the collar 58.

The anti-rotation protrusion 126 can also include a permanent magnet 178 configured to magnetically attract the rear surface 26 (FIGS. 6 and 7) to the anti-rotation protrusion 126. In the example provided, the front surface 146 of the anti-rotation protrusion 126 defines a recess 182 and the magnet 178 is received in the recess 182. In an alternative configuration, not specifically shown, the rear surface 26 (FIGS. 6 and 7) can include a magnet and the anti-rotation protrusion 126 can be formed of a ferromagnetic material or can include a ferromagnetic insert configured to align with and be attracted to the magnet of the rear surface 26 (FIGS. 6 and 7).

The top of the ring 158 can optionally include a flat surface 186 configured to permit a level (e.g., a spirit level or digital level) to identify a rotational angle of the ring 158, and thus the anti-rotation inset 154, relative to the collar 58 (FIG. 5). In the example provided, the flat surface 186 is perpendicular to the front surface 162 of the ring 158. In an alternative form, the top of the anti-rotation protrusion 126 can be flat to permit rotational alignment via a level.

Referring to FIGS. 5 and 10, the ring 158 can optionally include one or more rear magnets 190 configured to secure the anti-rotation inset 154 to a base 210 of the test fixture 42b when the anti-rotation protrusion 126 is not being used. In other words, the anti-rotation inset 154 can be slid axially along the tube 62 away from the collar 58 and secured by the rear magnet 190 in a stowed position (not shown) in which a rear surface 194 of the ring 158 engages a forward surface 214 of the base 210. In the example provided, each rear magnet 190 is received in a corresponding recess 196 defined by the rear surface 194, though other configurations can be used.

Referring to FIGS. 6 and 8, the forward surface 146 of the anti-rotation protrusion 126 can optionally define one or more alignment feature 198 and the rear surface 26 of the cover 22 can define a corresponding number of the alignment features 114. The alignment features 114 are configured to mate with or otherwise engage the alignment features 198 to ensure the helmeted headform 90b is properly aligned with the anti-rotation protrusion 126. In the example provided, the alignment features 198 are recesses and the alignment features 114 are protrusions configured to be received in the alignment features 198, though other configurations can be used. In another form, the alignment features 198 can be protrusions and the alignment features 114 can be recesses.

While not specifically shown, the forward surface 162 of the ring 158 can include one or more alignment feature (e.g., similar to alignment feature 198) and the rear surface 166 of the collar 58 can include a mating alignment feature (e.g., similar to alignment feature 114) that can cooperate with the alignment features of the forward surface 146 to properly align the anti-rotation inset 154 relative to the collar 58.

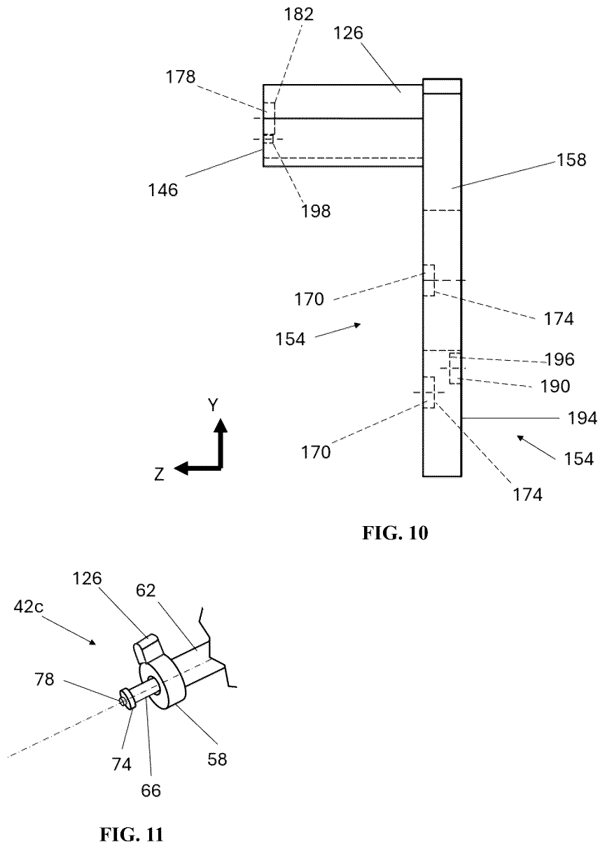

Referring to FIG. 11, a test fixture 42c of a second form is illustrated. The test fixture 42c can be similar to the test fixture 42b except as otherwise shown or described herein. As such, similar features are denoted by similar reference numerals and only differences or additional details are described in detail herein. The anti-rotation protrusion 126 is directly coupled to a perimeter of the collar 58 and is not coupled to a separate ring (i.e., the ring 158 shown in FIGS. 5 and 8-10). In one form, the anti-rotation protrusion 126 is integrally formed with the collar 58, such as via a single casting or through additive manufacturing, for example. In another form, the anti-rotation protrusion 126 is permanently affixed (e.g., welded) directly to the collar 58. In yet another form, the anti-rotation protrusion 126 is removably affixed (e.g., via screws or adhesive) to the collar 58.

A method of testing a helmeted headform will now be described with reference to FIGS. 5-7. For the sake of clear explanation, this method might be described with reference to particular elements or modules of the foregoing description. However, it should be noted that other elements or modules, whether explicitly described herein or created in view of the present disclosure, can be substituted for those referenced without departing from the scope of the present invention. Accordingly, the method of the present disclosure is not limited to any particular element(s) that perform(s) any particular functions. Furthermore, the steps of the method presented herein need not necessarily occur in the order described and/or some steps might occur simultaneously. These and other variations of the disclosed method will be readily apparent in view of this disclosure and are considered to be within the scope of the invention.

The method can optionally include attaching the anti-rotation protrusion 126 to the collar 58, such as in configurations where the anti-rotation protrusion 126 is separable from the collar 58. In one form, this can be accomplished by positioning the ring 158 coaxially around the tube 62 so that its forward surface 162 engages the rear surface 166 of the collar 58 as described above. The rotational position (about the axis 82) of the anti-rotation protrusion 126 may be checked by placing a level (not shown, e.g., a spirit level) on the flat surface 186 (FIG. 8).

Referring to FIG. 7, the method includes positioning the helmeted headform 90b in a mounted position. In this mounted position, the piston 66 (FIG. 5) is in a retracted state, compared to an extended state (shown in FIG. 5). In the extended state (FIG. 5), the piston 66 extends further out of the collar 58 than in the retracted state. In the retracted state, the rear aperture 38 (FIG. 6) receives the tip 78 (FIG. 5) and the lower region of the rear surface 26 opposes and engages the forward surface 138 of the collar 58 and the upper region of the rear surface 26 opposes and engages the forward surface 146 of the anti-rotation protrusion 126. In this position, the helmeted headform 90b is supported by the arm 54. In one form, the helmeted headform 90b is supported on the arm 54 by the magnet 134 (FIG. 5), the magnet 178 (FIG. 8), and/or friction between the tip 78 (FIG. 5) and the rear aperture 38 (FIG. 6). In this position, the alignment features 198 (FIG. 8) can engage the alignment features 114 (FIG. 6).

Referring to FIG. 5, from the mounted position (shown in FIG. 7), the propulsion device 70 can be activated such as by a control module to extend the piston 66 to the extended state. The propulsion device 70 can extend the piston 66 at a predetermined speed, acceleration, and/or force. The impact object 46b is positioned sufficiently far enough from the fixture 42b such that the helmeted headform 90b cannot simultaneously touch both the impact object 46b and the piston 66, even in the extended state of the piston 66. The force imparted on the helmeted headform 90b from the extending piston 66 is sufficient to eject the helmeted headform 90b from the fixture 42b such that the helmeted headform 90b travels freely through the air toward the impact object 42b. As described above, the anti-rotation protrusion 126 inhibits rotation of the helmeted headform 90b during the ejection process. The magnets 170 (FIG. 8) are of sufficient strength to maintain the position of the anti-rotation protrusion 126 during the ejection process. However, the magnet 134 (and optionally magnet 178) are of a strength such that their attraction to the helmeted headform 90b is overcome by the ejection process.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. An impact test system comprising:
an arm configured to support a helmeted headform in a mounted position, the helmeted headform including a headform wearing a helmet, the arm including:
a tube disposed about a translation axis;
a collar disposed about the translation axis and coupled to an end of the tube, the collar including a lower contact surface configured to abut a lower rear portion of the headform in the mounted position;
an anti-rotation protrusion coupled to the collar and including an upper contact surface that is radially outward of the lower contact surface and is configured to abut an upper rear portion of the headform in the mounted position; and
a piston extending within the tube and coupled to the tube for translation relative thereto along the translation axis between a retracted position and an extended position such that an end portion of the piston is configured to push the headform out of the mounted position and eject the helmeted headform away from the collar toward an impact surface, free from the arm.

2. The impact test system according to claim 1, wherein the protrusion is located above the collar.

3. The impact test system according to claim 1, wherein the collar includes a magnet configured to magnetically couple the lower rear portion to the collar.

4. The impact test system according to claim 1, wherein the protrusion includes a magnet configured to magnetically couple the upper rear portion to the protrusion.

5. The impact test system according to claim 1, wherein the lower contact surface is a first planar surface having an annular shape disposed coaxially about the translation axis and the upper contact surface is a second planar surface coplanar with the first planar surface.

6. The impact test system according to claim 1, wherein the protrusion is removably coupled to the collar.

7. The impact test system according to claim 6, wherein the arm further comprises: a ring defining a central aperture disposed coaxially about the tube and axially translatable relative to the tube, wherein a proximal end of the protrusion is fixedly coupled to the ring and the protrusion extends axially forward of a front of the ring to a distal end of the protrusion, the distal end of the protrusion defining the upper contact surface.

8. The impact test system according to claim 7, wherein the distal end of the protrusion includes a magnet configured to magnetically couple the upper rear portion to the protrusion.

9. The impact test system according to claim 7, wherein at least one of the collar and the ring includes a magnet configured to magnetically couple the front of the ring to a rear of the collar.

10. The impact test system according to claim 7, wherein the ring and the protrusion are integrally formed of a non-ferromagnetic material.

11. The impact test system according to claim 7, wherein the proximal end of the protrusion is coupled directly to the front of the ring.

12. The impact test system according to claim 7, wherein the protrusion includes a flat surface facing radially outward, relative to the translation axis.

13. The impact test system according to claim 7, wherein the front of the ring includes an alignment feature configured to mate with a mating alignment feature defined by a rear of the collar to inhibit rotation of the ring about the translation axis relative to the collar, wherein the alignment feature is one of a protrusion and a recess and the mating alignment feature is the other one of the protrusion and the recess.

14. The impact test system according to claim 7, further comprising a magnet fixedly coupled to a rear of the ring.

15. An anti-rotation insert for an impact test system, the anti-rotation insert comprising:
a ring defining a central aperture disposed about a central axis and extending through a front of the ring and a rear of the ring; and
a protrusion, wherein a proximal end of the protrusion is fixedly coupled to the ring and the protrusion extends axially forward of the front of the ring to a distal end of the protrusion; and
a first magnet coupled to the distal end of the protrusion.

16. The anti-rotation insert according to claim 15, further comprising a second magnet, the second magnet being fixedly coupled to the front of the ring.

17. The anti-rotation insert according to claim 15, wherein the ring and the protrusion are integrally formed of a non-ferromagnetic material.

18. The anti-rotation insert according to claim 15, wherein the front face includes an alignment feature configured to mate with a mating alignment feature of a test fixture to inhibit rotation of the ring about the central axis relative to the test fixture, wherein the alignment feature is one of a protrusion and a recess and the mating alignment feature is the other one of the protrusion and the recess.

19. A method of testing a helmeted headform, the helmeted headform including a headform wearing a helmet, the method comprising:
positioning the helmeted headform in a mounted position, wherein in the mounted position, an arm of a test fixture extends through an opening of the helmet and is attached to the headform within the helmet, wherein in the mounted position, a collar of the arm contacts a first portion of the headform within the helmet and a protrusion of the arm contacts a second portion of the headform within the helmet, wherein the first portion is disposed about a translation axis and the protrusion protrudes radially outward from the collar; and
impacting an object with the helmeted headform by extending an ejector relative to the collar to an extended position such that an end of an ejector moves forward of the collar to cause the helmeted headform to be ejected from the arm toward the object.

20. The method according to claim 19, wherein the protrusion and the collar are magnetically coupled to the headform in the mounted position.
